(19) United States
(12) Patent Application Publication
(10) Pub. No.: US 2026/0262882 A1
(43) Pub. Date: Sep. 10, 2026

(54) PELLET FUELED COOKING APPLIANCE WITH AN IMPROVED HOPPER CONFIGURATION

(71) Applicant: North Atlantic Imports, LLC, Logan, UT (US)

(72) Inventor: Jared Smith, Logan, UT (US)

(73) Assignee: North Atlantic Imports, LLC, Logan, UT (US)

(21) Appl. No.: 19/556,787

(22) Filed: Mar. 4, 2026

Related U.S. Application Data
(60) Provisional application No. 63/767,406, filed on Mar. 5, 2025.

(51) Int. Cl. A47J 37/07; F23K 3/14

(52) U.S. Cl. CPC A47J 37/0704; F23K 3/14; F23K 2203/20

(57) ABSTRACT

A pellet fueled cooking appliance is provided. The pellet fueled cooking appliance includes a cooking body, which defines a cooking chamber, and a burner positioned to heat the cooking chamber when pellets are burned in the burner. The pellet fueled cooking appliance also includes a pellet hopper having a hopper inlet and a hopper outlet. The hopper outlet is configured to feed pellets from the hopper into the burner. A hopper shaker is mounted to the pellet hopper. The hopper shaker is configured to impart a vibration to the pellet hopper to facilitate the flow of pellets through the pellet hopper and into the burner.

### CROSS-REFERENCE TO RELATED APPLICATIONS

The present application claims the benefit of and priority to U.S. Provisional Patent Application No. 63/767,406, filed on March 5, 2025, the entire contents of which are hereby incorporated by reference herein.

### BACKGROUND

The present application relates generally to the field of pellet fueled cooking appliances. More specifically, the present application relates to a pellet fueled cooking appliance with an improved hopper configuration.

### SUMMARY

One embodiment of the present disclosure relates to a pellet fueled cooking appliance. The pellet fueled cooking appliance includes a cooking body, which defines a cooking chamber, and a burner positioned to heat the cooking chamber when pellets are burned in the burner. The pellet fueled cooking appliance also includes a pellet hopper having a hopper inlet and a hopper outlet. The hopper outlet is configured to feed pellets from the hopper into the burner. A hopper shaker is mounted to the pellet hopper. The hopper shaker is configured to impart a vibration to the pellet hopper to facilitate the flow of pellets through the pellet hopper and into the burner.

In some embodiments, the hopper shaker includes a shaker motor having a motor shaft and an eccentric weight coupled to the motor shaft. In some embodiments, the motor shaft is oriented substantially parallel to an axis extending between the hopper inlet and the hopper outlet. In some embodiments, an elastomer member is positioned between the hopper shaker and the pellet hopper to dampen vibrations imparted by the hopper shaker to the pellet hopper. In some embodiments, the hopper shaker is mounted to an inside surface of the pellet hopper. In some embodiments, an elastomer member is positioned between the pellet hopper and the cooking body to dampen vibrations imparted by the pellet hopper to the cooking body. In some embodiments, the pellet fueled cooking appliance includes a control system configured to periodically energize the hopper shaker throughout a cooking cycle. In some embodiments, the control system is configured to receive an input indicative of a desired cooking temperature and to periodically energize the hopper shaker throughout the cooking cycle at a rate related to the desired cooking temperature. In some embodiments, the pellet fueled cooking appliance includes an electrical switch mounted to the cooking body and configured to selectively energize the hopper shaker.

One embodiment of the present disclosure relates to a method of fueling a cooking appliance. The method includes the step of feeding pellets disposed within a pellet hopper from the pellet hopper into a burner. The method also includes the step of igniting pellets received in the burner. Finally, the method includes the step of energizing a hopper shaker mounted to the pellet hopper to facilitate the flow of pellets disposed within the pellet hopper from the pellet hopper to the burner.

In some embodiments, energizing the hopper shaker includes selectively energizing the hopper shaker with an electrical switch mounted to the cooking appliance. In some embodiments, energizing the hopper shaker includes periodically energizing the hopper shaker at a rate related to a cooking temperature. In some embodiments, energizing the hopper shaker includes receiving a first input indicative of a desired cooking temperature and periodically energizing the hopper shaker at a rate related to the desired cooking temperature. In some embodiments, energizing the hopper shaker includes receiving a first input indicative of a first desired cooking temperature, periodically energizing the hopper shaker at a first rate related to the first desired cooking temperature, receiving a second input indicative of a second desired cooking temperature, and periodically energizing the hopper shaker at a second rate that is related to the second desired cooking temperature but is different from the first rate.

One embodiment of the present disclosure relates to a pellet grill. The pellet grill includes a cooking body, which defines a cooking chamber. A pellet hopper is coupled to the cooking body and has a hopper outlet. A fire pot is disposed within and is configured to heat the cooking chamber. An auger housing extends between the hopper outlet and the fire pot. An auger is positioned within the auger housing and also extends between the auger housing and the fire pot. An auger motor is coupled to the auger and configured to rotate the auger within the auger housing to feed pellets from the hopper outlet to the fire pot. A hopper shaker is mounted to the pellet hopper and is configured to impart a vibration to the pellet hopper to facilitate the flow of pellets through the hopper and into the fire pot.

In some embodiments, the hopper shaker is vibrationally isolated from the pellet hopper by an elastomer member configured to dampen vibrations imparted by the hopper shaker to the pellet hopper. In some embodiments, the pellet hopper is vibrationally isolated from the cooking body by an elastomer member configured to dampen vibrations imparted by the pellet hopper to the cooking body. In some embodiments, the pellet grill includes a control system configured to periodically energize the hopper shaker throughout a cooking cycle. In some embodiments, the control system is configured to receive an input indicative of a desired cooking temperature and to periodically energize the hopper shaker throughout the cooking cycle at a rate related to the desired cooking temperature. In some embodiments, the pellet grill includes an electrical switch coupled to the cooking body and configured to selectively energize the hopper shaker.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a cross-sectional view of a pellet fueled cooking appliance equipped with a hopper shaker, according to some embodiments of the present disclosure;

FIG. 2 depicts a pellet grill equipped with a hopper shaker, according to some embodiments of the present disclosure;

FIG. 3 is a partial cross-sectional view of a pellet hopper of a pellet fueled cooking appliance equipped with a hopper shaker, according to some embodiments of the present disclosure;

FIG. 4 is a partial cross-sectional view of a pellet fueled cooking appliance equipped with a hopper shaker, according to some embodiments of the present disclosure;

FIG. 5 is an exploded view of a hopper shaker, according to some embodiments of the present disclosure;

FIG. 6 is a block diagram of a control system for a pellet fueled cooking appliance, according to some embodiments of the present disclosure;

FIG. 7 is a flow chart of a method for fueling a pellet fueled cooking appliance, according to some embodiments of the present disclosure;

FIG. 8 is a flow chart of a method for energizing a hopper shaker during the fueling of a pellet fueled cooking appliance, according to some embodiments of the present disclosure.

### DETAILED DESCRIPTION

Pellet fueled cooking appliances are those that burn pellets as a source of cooking heat. A typical pellet fueled cooking appliance has a hopper for receiving a volume of fuel (e.g., wood) pellets. Pellets are fed from the hopper to a burner, where they are consumed throughout a cooking process. However, pellets can become stuck or bound within the hopper and either starve the burner of fuel or, at least, create an inconvenience for the operator of the appliance. Binding can arise when foreign objects are inadvertently introduced to the hopper or as pellets absorb moisture from the ambient environment. Additionally, some hoppers are designed to maximize storage volume at the expense of efficient feed characteristics, making binding and stuck pellets an inherent problem.

Referring generally to the FIGURES, a pellet fueled cooking appliance (e.g., a pellet grill, pellet smoker, pellet fired pizza oven, pellet fired oven, etc.) including a shaker, or vibrator, mounted to the hopper is provided. By including, and controllably energizing, a shaker, the efficient flow of pellets through, and improved drainage of pellets from, hoppers of different sizes, geometries, and configurations is achieved. Accordingly, the pellet fueled cooking appliance and method of fueling such a cooking appliance disclosed herein provide improved operating characteristics and greater convenience to the operator.

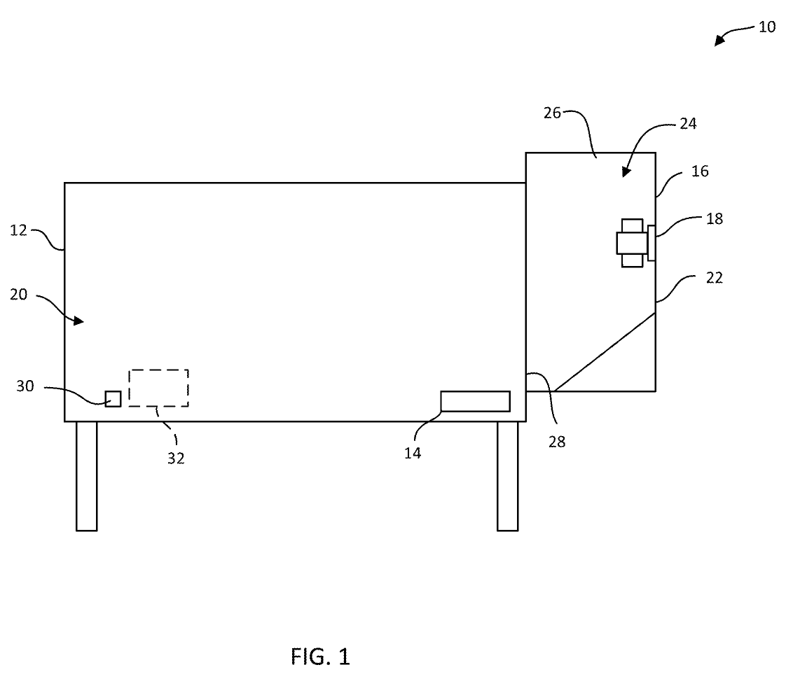

In some embodiments of the present disclosure, and as shown in FIG. 1, a pellet fueled cooking appliance 10 comprises a cooking body 12, a burner 14, a pellet hopper 16, and a hopper shaker 18. The cooking body 12 includes one or more parts that, in combination, define a cooking chamber 20 wherein food may be prepared. For example, the cooking body 12 may include a grill body and a lid rotatably coupled to the grill body to define the cooking chamber 20 therebetween. The cooking body 12 may alternatively include an oven body and a door rotatably or slidably coupled to the oven body to define the cooking chamber 20. The cooking body 12 may have or be configured to receive, within the cooking chamber 20, one or more racks, trays, or surfaces on which food to be cooked may be placed. The cooking body 12 contains and directs heat generated in the cooking chamber 20 by creating a barrier between the cooking chamber and the ambient environment.

The burner 14 is a vessel for receiving fuel pellets and for confining them as they are burned. In some embodiments, the burner 14 is a fire pot having a circular base and a cylindrical side wall. In other embodiments, the burner 14 is a pellet tray having a flat base and a relatively short sidewall. In some embodiments a side wall of the burner 14 defines one or more apertures through which air may be introduced to oxygenate a fire burning in the burner 14. In some embodiments, a base of the burner 14 defines a grate through which ash produced by the burning of fuel pellets may exit so as to not smother the remaining fuel pellets and to permit the introduction of additional fuel pellets into the burner 14. In some embodiments, the burner 14 includes or is coupled to an igniter to ignite fuel pellets received therein.

The burner 14 heats the cooking chamber 20. The burner 14 is positioned to introduce heated air and smoke produced by burning fuel pellets therein into the cooking chamber 20. In some embodiments, the burner 14 is positioned inside the cooking chamber 20 so that the heated air and smoke produced in the burner 14 are introduced directly into the cooking chamber 20. In other embodiments, the burner 14 is positioned outside of the cooking chamber 20 but is in gaseous communication with the cooking chamber 20 so that the heated air and smoke produced in the burner 14 are indirectly introduced into the cooking chamber 20.

The pellet hopper 16 is an apparatus to receive, hold, and dispense fuel pellets to the burner 14. The pellet hopper 16 includes one or more side walls 22 that define a storage volume 24. The pellet hopper includes a hopper inlet 26 for receiving fuel pellets to be held within the storage volume 24 and a hopper outlet 28 for dispensing fuel pellets held within the storage volume 24. As shown in FIG. 1, the hopper outlet 28 may be positioned below the hopper inlet 26, along a vertical axis, so that gravity forces fuel pellets received at the hopper inlet 26 through the storage volume 24 and towards the hopper outlet 28. The pellet hopper may have one or more angled, or slanted, side walls to facilitate the flow of fuel pellets held within the storage volume 24 toward the hopper outlet 28. In some embodiments, the pellet hopper 16 is mounted to the cooking body 12 with the hopper outlet 28 positioned to feed fuel pellets directly into the burner 14 through an aperture defined by the cooking body 12. The hopper outlet 28 may be sized to regulate the rate at which fuel pellets are dispensed into the burner 14. In some embodiments, the pellet fueled cooking appliance includes an auger assembly to controllably convey fuel pellets from the hopper outlet 28 to the burner 14.

The hopper shaker 18 is a device used to shake, vibrate or otherwise agitate the pellet hopper 16 to move, displace, or loosen fuel pellets held within the storage volume 24, thus reducing their resistance to gravity and facilitating their dispensation through the hopper outlet 28. The hopper shaker 18 may be an electric shaker having an electric motor configured to drive an eccentric or offset weight to convert rotational motion of the motor into an oscillatory or vibrating motion. The hopper shaker 18 is mounted to a surface of the pellet hopper 16. In some embodiments, and as shown in FIG. 1, the hopper shaker 18 is mounted to a side wall 22 of the pellet hopper 16. In some embodiments, the hopper shaker 18 is mounted to a side wall 22 opposite the burner 14 so that the hopper shaker 18 is not heated due to its proximity to the burner 14. In some embodiments, the hopper shaker 18 is mounted to an inside surface of a side wall 22 such that the hopper shaker is within the storage volume 24 of the pellet hopper 16. The oscillations or vibrations produced by the hopper shaker 18 are transmitted to the pellet hopper 16 at the location where the hopper shaker 18 is mounted to the pellet hopper 16. The oscillations or vibrations are then imparted to the fuel pellets held within the storage volume 24 of the pellet hopper 16. The vibrations cause the fuel pellets to move relative to one another and relative to the pellet hopper 16, encouraging consistent movement or flow through the storage volume 24 and out of the hopper outlet 28.

In some embodiments, the pellet fueled cooking appliance 10 includes an electrical switch 30 (e.g., a latching or momentary toggle or push-button switch) to selectively energize the hopper shaker 18. The electrical switch 30 may be mounted to the cooking body 12 so that it is accessible and operable to a user of the pellet fueled cooking appliance 10. In some embodiments, the pellet fueled cooking appliance 10 includes a control system 32 configured to, among other things, receive an input or inputs from a user and to controllably energize the hopper shaker 18. The control system 32 may be mounted to or housed within the cooking body of the pellet fueled cooking appliance 10. In some embodiments, the control system 32 receives the input or inputs from a user interface local to the pellet fueled cooking appliance 10. The user interface may include a touchscreen or one or more knobs, buttons, switches, dials, etc., for manual manipulation by a user. In some embodiments, the control system 32 receives the input or inputs from an application operating on a network connected device (e.g., a cell phone, smart phone, computer, laptop, etc.) in wired or wireless communication with the control system 32. The network connected device may communicate directly with the control system 32, or it may communicate with the control system 32 through an internet or cloud-based service.

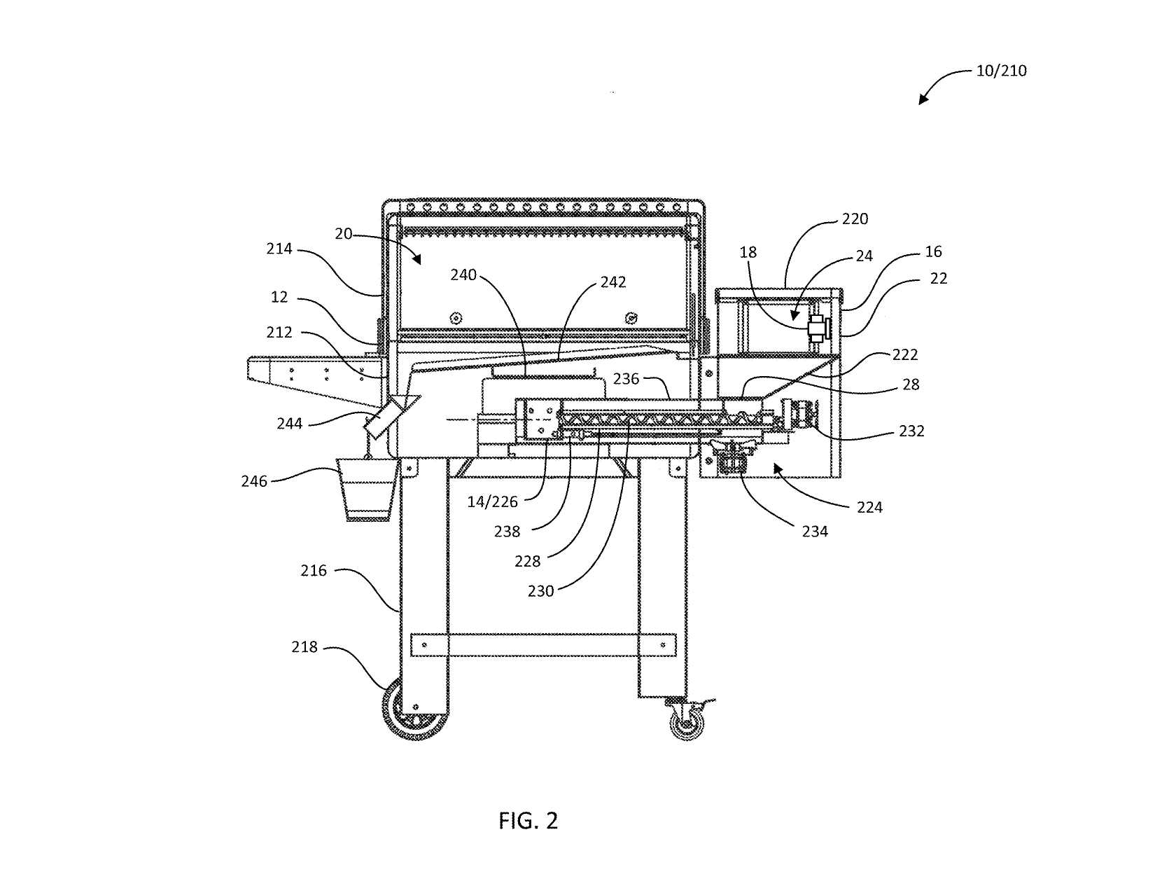

In some embodiments of the present disclosure, and as shown in FIG. 2, the pellet fueled cooking appliance 10 is a pellet grill 210. The cooking body 12 includes a grill body 212 and a hood 214 pivotably coupled to the grill body 212 and movable between a fully opened position and a fully closed position. When the hood 214 is in the fully closed position, the hood 214 and the grill body define the cooking chamber 20 therebetween. When the hood 214 is in the fully opened position, food to be cooked can be placed in the cooking chamber 20. Movement of the hood 214 between the fully opened position and fully closed position can be achieved manually with a handle coupled to the hood 214. In some embodiments, the hood is a partial barrel like structure, having a first end and a second end with a radial hood wall extending between the first end and the second end. The cooking chamber 20 may be configured to receive one or more grill racks on which food to be cooked may be placed. One or more (e.g., one, three, four, etc.) legs 216 may be coupled to and extend downward from the grill body 212 to provide elevation and stability to the pellet grill 210. One or more of the one or more legs 216 may have a wheel 218 (e.g., a caster wheel, etc.) attached to the end of the leg opposite the grill body 212 to allow the pellet grill 210 to be more easily moved.

The pellet hopper 16 is coupled to the cooking body 12 of the pellet grill 210. The pellet hopper 16 may include a lid 220 that may be opened to access the storage volume 24 of the pellet hopper 16 and to deposit pellets therein. One of the one or more side walls 22 of the pellet hopper 16 may be a slanted side wall 222 extending towards the hopper outlet 28 to facilitate the flow of pellets held within the storage volume 24 to the hopper outlet 28. The hopper outlet 28 is positioned to feed an auger assembly 224 that is configured to feed pellets from the pellet hopper 16 to the burner 14, shown here as a fire pot 226. The auger assembly 224 includes an auger housing 228 and an auger 230. The auger housing 228 is a tubular body extending between the hopper outlet 28 and the fire pot 226. The auger 230 similarly extends between the hopper outlet 28 and the fire pot 226. The auger 230 is positioned within the auger housing 228 and sized so that when rotated about an axis defined by the auger 230, pellets are conveyed from the hopper outlet 28 along the axis to the fire pot 226. The auger assembly 224 may include an auger motor 232 configured to rotate the auger 230. The auger motor 232 may be controllably energized by the control system 32. The control system 32 may controllably energize the auger motor 232 to fuel the fire pot 226 in a manner to maintain or achieve a desired cooking temperature indicated by the user of the pellet grill 210.

The hopper shaker 18 is mounted to a side wall 22 of the pellet hopper opposite the cooking body 12 to minimize exposure to heat generated within the cooking body 12. The hopper shaker 18 is mounted to an inner surface of the side wall 22 so that the hopper shaker 18 is disposed within the storage volume 24 of the pellet hopper 16. In some embodiments, and as previously discussed in reference to FIG. 1, the hopper shaker 18 is an electric hopper shaker. The hopper shaker may be selectively energized by manually operating an electrical switch 30 located on or near the pellet grill 210. Additionally, or alternatively, the hopper shaker 18 may be controllably energized by the control system 32 in a manner to achieve or maintain a desired cooking temperature indicated by the user of the pellet grill 210.

The fire pot 226 has a round bottom and a cylindrical side wall. The side wall defines one or more apertures through which air may be introduced to oxygenate a fire burning in the fire pot 226. In some embodiments, the pellet grill includes a fan 234 configured to force air through the one or more apertures defined by the side wall of the fire pot 226. The fan 234 may be an electric motor driven fan. In some embodiments, a duct 236 extends between the fire pot 226 and the fan 234 so that the fan can be located some distance away from the fire pot 226 to minimize exposure to heat. In some embodiments, the duct 236 extends outside of the cooking body 12 so that the fan 234 may be positioned outside of the cooking chamber 20. In some embodiments, the duct 236 encloses the auger housing 228 and the auger 230. The fire pot 226 includes or is coupled to an igniter 238. The igniter 238 may be an electrical heating element extending at least partially into the fire pot 226 and configure to ignite pellets therein when electrically energized. The control system 32 may be configured to energize the igniter 238 in a manner to achieve or maintain a desired cooking temperature indicated by the user of the pellet grill 210. The control system 32 may further be configured to control the fan 234 in a manner to achieve or maintain a desired cooking temperature indicated by the user of the pellet grill 210.

The fire pot 226 is disposed centrally within the grill body 212 of the pellet grill 210 to heat the cooking chamber 20 as pellets are burned. The fire pot 226 may be positioned below a flame shield 240. The flame shield 240 is an apparatus sized and configured to prevent flames generated in the fire pot 226 from directly contacting food disposed within the cooking chamber 20. A drip pan 242 may be positioned above the flame shield 240. The drip pan 242 is angled downward toward an aperture 244 defined by the grill body 212 so that, as food is cooked within the cooking chamber 20, drippings and other byproducts generated during the cooking process are directed out of the cooking body 12 and into a grease container 246 external to the cooking body 12. The drip pan 242 may include upward extending side walls to ensure drippings and other byproducts are funneled into the grease container 246. The drip pan 242, being so positioned, ensures that grease and other food byproducts do not smother the pellets burning in the fire pot 226 or enter into and disrupt the operation of the auger assembly 224.

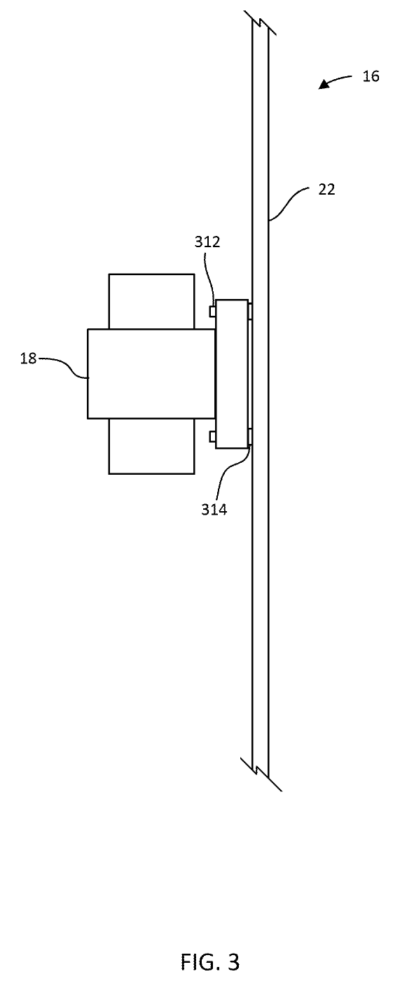

In some embodiments of the present disclosure, and as shown in FIG. 3, the hopper shaker 18 is mounted to a side wall 22 of the pellet hopper 16 with one or more fasteners 312 (e.g., one or more screws, nuts, bolts, clips, etc.). In some embodiments, one or more vibration dampening components 314 are included between, or partially between, the hopper shaker 18 and the side wall 22 of the pellet hopper 16 to which the hopper shaker 18 is mounted. The one or more vibration dampening components 314 may be elastomer components (e.g., rubber gaskets, washers, grommets, etc.). The one or more vibration dampening components 314 reduce noise or rattling that may result from direct contact between the hopper shaker 18 and the side wall 22 of the pellet hopper 16. The one or more vibration dampening components 314 also reduce the amount or magnitude of the vibrations imparted directly to the one or more fasteners 312, and, therefore, reduce wear on, and prevent early failure of, the one or more fasteners 312. The inherent flexibility of elastomers allows the one or more vibration dampening components 314 made of an elastomer to absorb these unwanted vibrations, while still allowing the hopper shaker 18 to impart vibrations to the pellet hopper 16.

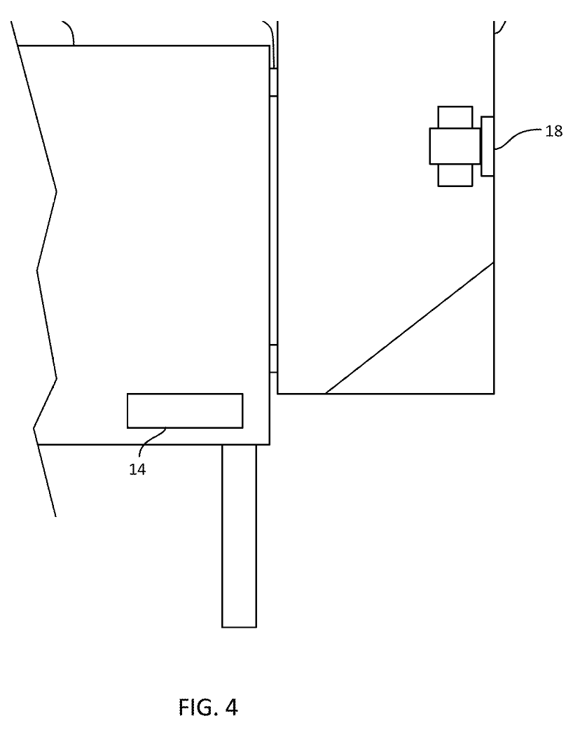

In some embodiments of the present disclosure, and as shown in FIG. 4, the pellet hopper 16 is vibrationally isolated from the cooking body 12 by one or more vibration dampening components 412. In some embodiments, the one or more vibration dampening components 412 may be an elastomer component (e.g., a rubber gasket, washer, grommet, etc.). The one or more vibration dampening components 412 reduces the amount or magnitude of vibrations imparted to the cooking body 12 by the pellet hopper 16. The inherent flexibility of elastomers allows the one or more vibration dampening components 412 made of an elastomer to absorb vibrations that would otherwise be imparted to the cooking body 12 by the pellet hopper 16 being vibrated by the hopper shaker 18.

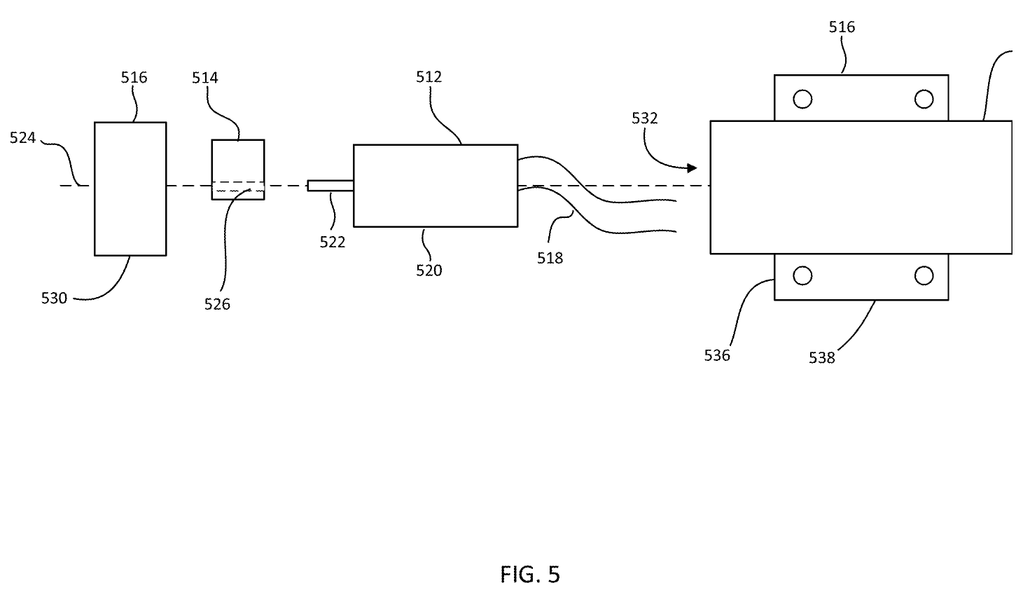

In some embodiments of the present disclosure, and as shown in FIG. 5, the hopper shaker 18 is an electric shaker including a shaker motor 512, a shaker weight 514, and a shaker housing 516. The shaker motor 512 is an electric motor (e.g., a brushed DC motor, a brushless DC motor, an induction AC motor, a synchronous AC motor, etc.). The shaker motor 512 includes one or more wires 518 to provide electrical energy to the shaker motor 512, a motor casing 520 adapted to house various components of the electrical motor (e.g., a rotor, a stator, bearings, bushings, brushes, commutators, etc.), and a motor shaft 522 extending out of the motor casing 520. The motor shaft 522 is configured to rotate about an axis 524 defined by the motor shaft 522 when the shaker motor 512 is electrically energized.

The shaker weight 514 is an eccentric, or offset, weight having a bore 526 configured to receive the motor shaft 522. The shaker weight 514 is coupled to the motor shaft 522 (e.g., by a set screw, adhesive, weld, etc.). When the shaker motor 512 is electrically energized, the shaker weight 514 provides an unbalanced load on the motor shaft 522 that generates vibrations. In some embodiments, the vibrations are substantially along a plane perpendicular to the axis 524 defined by the motor shaft 522. In some embodiments, the eccentricity of the shaker weight 514 is configured to produce low amplitude vibrations. In other embodiments, the degree of eccentricity of the shaker weight 514 is adjustable to vary the magnitude of the vibrations created by the hopper shaker 18.

The shaker housing 516 stably encloses and protects the shaker motor 512 and shaker weight 514 from dust, debris, and other environmental factors. The shaker housing 516 also provides a means by which the hopper shaker 18 can be mounted, and transfer vibrations, to the pellet hopper 16. In some embodiments, and as shown in FIG. 5, the shaker housing 516 includes a main body 528 and a maintenance cap 530. The main body 528 defines an inner volume 532 in which the shaker motor 512 is securely disposed. The main body 528 defines an aperture 534 through which the one or more wires 518 of the shaker motor 512 are passed. In some embodiments, the aperture 534 is sealed (e.g., by a grommet, potting, adhesive, etc.) to minimize the introduction of dust, debris, or other environmental factors into the shaker housing 516 through the aperture 534. The main body 528 has one or more mounting members to securely mount and transfer vibrations from the hopper shaker 18 to the pellet hopper 16. For example, and as shown in FIG. 5, the main body 528 has one or more mounting flanges 536 extending from the main body 528. The one or more mounting flanges 536 define one or more mounting apertures 538 through which screws, bolts, studs, etc. can be passed to mount the hopper shaker 18 to the pellet hopper 16.

The main body 528 and the maintenance cap 530 of the shaker housing 516 are configured to be removably coupled. When removed, the maintenance cap 530 enables maintenance of the shaker motor 512 or adjustment of the shaker weight 514. When the maintenance cap 530 is coupled to the main body 528, the maintenance cap completely encloses the inner volume 532 in which the shaker motor 512 and shaker weight 514 are disposed, preventing dust, debris, and other environmental factors from entering the inner volume 532 and interfering with the operation of the shaker motor 512.

In some embodiments of the present disclosure, and as shown in FIGS. 1, 2, 3 and 4, the hopper shaker 18 is mounted so that the axis 524 defined by the motor shaft 522 of the shaker motor 512 is substantially parallel to an axis extending between the hopper inlet 26 and the hopper outlet 28 so that the plane along which vibrations are created by the hopper shaker 18 is parallel to a surface on which the pellet fueled cooking appliance 10 is set. By orienting the hopper shaker 18 in this manner, vibration between the pellet fueled cooking appliance 10 and the surface on which it is set is minimized, resulting in less perceived vibration by a user of the pellet fueled cooking appliance 10.

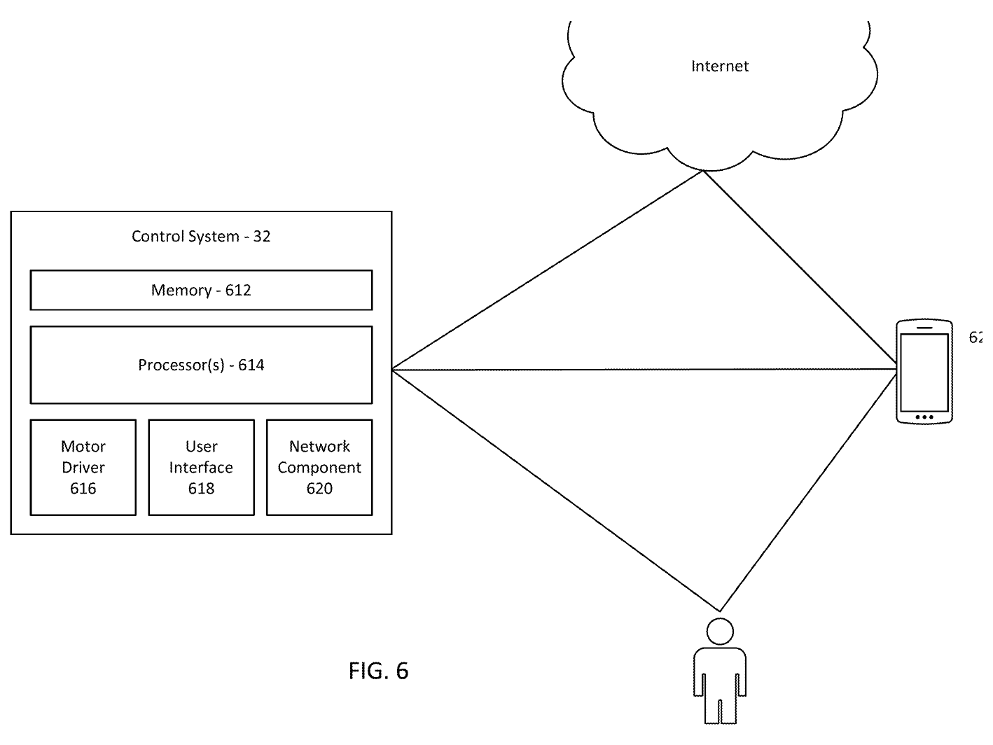

In some embodiments of the present disclosure, and as shown in FIG. 6, the pellet fueled cooking appliance 10 includes a control system 32 to controllably energize the hopper shaker 18. The control system 32 includes a non-transitory memory 612, one or more processors 614, and a motor driver 616. The memory 612 stores instructions to be executed by the one or more processors 614. The memory 612 may include read-only memory (e.g., EPROM, EEPROM, etc.), random-access memory (e.g., SRAM, DRAM, etc.), flash memory, cache memory, non-volatile random-access memory, and/or any other suitable memory device known to those of ordinary skill in the art. The memory 612 may be integral to the control system 32, or the memory 612 may be external to and in communication with the control system 32. The one or more processors 614 may include a microprocessor or one or more components configured to nonetheless execute instructions stored in the memory 612. The one or more processors 614 may include a component of a microcontroller, an application specific integrated circuit, or a system on chip. In some embodiments, the one or more processors 614 are implemented on a field programmable gate array or a complex programable logic device.

The motor driver 616 is an electrical component, or combination of electrical components, configured to energize the hopper shaker 18 according to instructions executed, and parameters set, by the one or more processors 614. The motor driver 616 may include an H-bridge, a stepper motor driver, a brushless DC motor driver, a servo motor driver, or one or more relays or contactors. The motor driver 616 may be integral to the control system 32 or the motor driver 616 may comprise one or more discrete components in communication with the control system 32. The motor driver 616 may be configured to drive the shaker motor 512 of the hopper shaker 18 at a specific frequency. For example, it may be desirable to drive the shaker motor 512 at a high frequency to minimize the vibration perceived by the user of the pellet fueled cooking appliance 10.

In some embodiments of the present disclosure, the control system 32 includes a user interface 618. The user interface 618 receives manual input from a user of the pellet fueled cooking appliance 10. The user interface 618 may include one or more knobs, buttons, switches, dials, or etc. for manipulation by the user. For example, the user interface 618 may include a knob configured to receive a desired cooking temperature from the user of the pellet fueled cooking appliance 10. In some embodiments, the user interface includes a touch screen configured to present information to, and receive inputs from, the user. For example, the touch screen may be configured to provide the user with manipulable elements or graphics that allow the user to set a desired cooking temperature. Inputs received by the control system 32 at the user interface 618 may be stored in the memory 612 and/or used by the one or more processors 614 as it executes instructions stored in the memory 612.

In some embodiments of the present disclosure, the control system 32 is configured to receive user input by means of an application operating on a network connected device 622 (e.g., a cell phone, smart phone, computer, laptop, etc.). In such embodiments, the control system 32 includes a network component 620. The network component 620 may include one or more wireless communication devices (e.g., a Bluetooth or Wi-Fi radio) configured to enable the controller to send and receive data (e.g., user inputs) from the network connected device 622. In some embodiments, the control system 32 communicates directly with the network connected device 622. In other embodiments, the control system 32 communicates with the network connected device 622 through an internet or cloud-based service.

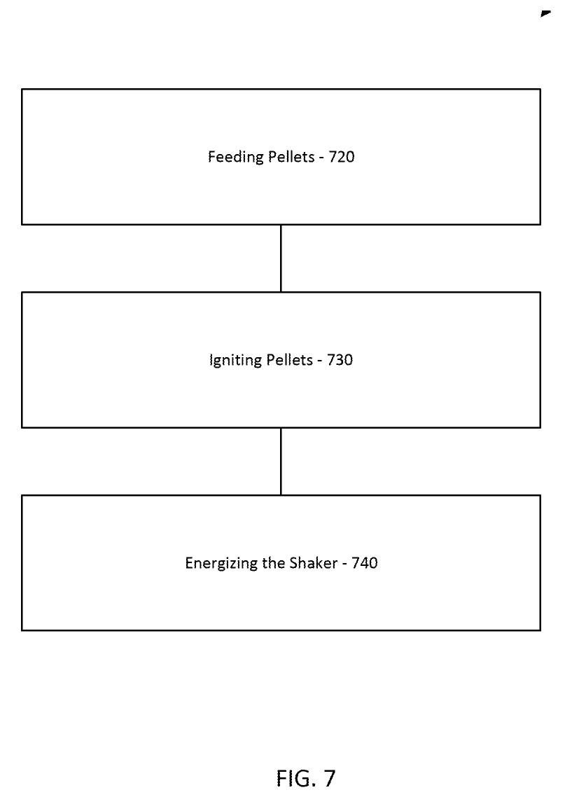

In accordance with some embodiments of the present disclosure, and as shown in FIG. 7, a method 710 of fueling a pellet fueled cooking appliance 10 is provided. The method 710 includes the step of feeding pellets 720 from the pellet hopper 16 to the burner 14. In some embodiments, fuel pellets are fed by gravity from the pellet hopper 16 to the burner 14. In other embodiments, fuel pellets are mechanically fed (e.g., by an auger or other conveying assembly) from the pellet hopper 16 to the burner 14. The step of feeding pellets 720 may be repeated as fuel pellets are consumed throughout a cooking cycle.

The method 710 of fueling a pellet fueled cooking appliance 10 also includes the step of igniting pellets 730 received within the burner 14 to heat the cooking chamber 20 of the pellet fueled cooking appliance 10. In some embodiments, ignition of fuel pellets received in the burner 14 is accomplished with an igniter integral or coupled to the burner 14. In other embodiments, ignition of fuel pellets received in the burner 14 is accomplished manually, that is, the user of the pellet fueled cooking appliance 10 ignites the fuel pellets received in the burner with a match, lighter, or some other fire starter. The step of igniting pellets 730 may be repeated if necessary, during the cooking cycle.

The method 710 of fueling a pellet fueled cooking appliance 10 also includes the step of energizing the shaker 740 to facilitate and aid the feeding of fuel pellets from the pellet hopper 16 to the burner 14. In some embodiments, the hopper shaker 18 is energize manually and selectively, by operating the electrical switch 30 configured to connect or disconnect the hopper shaker from an electrical energy source. In some embodiments, the hopper shaker 18 is controllably energized by the control system 32. In such embodiments, the control system 32 may be configured to energize and deenergize the hopper shaker 18 in a manner to achieve a particular cooking temperature within the cooking body 12 of the pellet fueled cooking appliance 10 and/or to maintain a temperature throughout a cooking cycle. For example, the control system 32 may periodically energize and deenergize the hopper shaker 18 at regular intervals (i.e., at a regular rate) that coincide with the rate at which pellets are consumed by the burner 14, and therefore relates to the desired cooking temperature, throughout a cooking cycle.

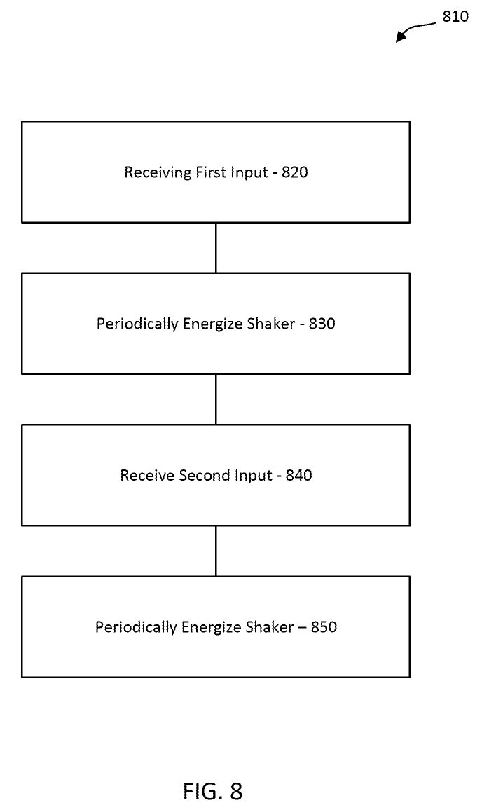

In some embodiments of the present disclosure, and as shown in FIG. 8, the control system 32 is configured to controllably energize the hopper shaker in a manner to achieve or maintain a desired cooking temperature indicated by the user of the pellet fueled cooking appliance 10. A method 810 for controllably energizing the hopper shaker 18 includes the step of receiving a first input 820. The first input indicates a desired cooking temperature. The first input may be provided by the user of the pellet fueled cooking appliance 10 at the user interface 618 of the control system 32. For example, the user of the pellet fueled cooking appliance may turn a knob to a position associated with a specific cooking temperature. In some embodiments, the first input may be provided by the user of the pellet fueled cooking appliance 10 by using a network connected device 622 configured to communicate with the control system 32. For example, the user of the pellet fueled cooking appliance 10 may enter a desired cooking temperature into a smart phone application.

The method 810 of controllably energizing the hopper shaker 18 includes the step of periodically energizing the shaker 830 to achieve or maintain the desired cooking temperature indicated by the first input. The hopper shaker 18 is periodically energized and deenergized, throughout the cooking cycle, at a rate related to, and intended to achieve, the desired cooking temperature indicated by the first input. In some embodiments, the rate at which the hopper shaker 18 is energized and deenergized will increase as the desired cooking temperature increases. For example, where the first input indicates a desired cooking temperature of 225 degrees Fahrenheit, the control system 32 may energize the hopper shaker 18 for a period of time and then deenergize the hopper shaker 18 for a period of approximately 30 minutes, before repeating the process. In another example, where the first input indicates a desired cooking temperature of 350 degrees Fahrenheit, the control system 32 may energize the hopper shaker 18 for a period of time and then deenergize the hopper shaker 18 for a period of approximately 15 minutes, before repeating the process.

During a cooking cycle, the user of the pellet fueled cooking appliance 10 may desire to change or adjust the cooking temperature within the cooking chamber 20. Accordingly, in some embodiments, the method 810 of controllably energizing the hopper shaker 18 includes the step of receiving a second input 840. The second input indicates a desired cooking temperature that is different than that indicated by the first input. Like the first input, the second input may be provided by the user of the pellet fueled cooking appliance at the user interface 618 of the control system 32 or by using a network connected device 622 configured to communicate with the control system 32. In some embodiments, the second input may be provided by a means different than the first input. For example, the first input may be provided by the user of the pellet fueled cooking appliance 10 at the user interface 618 of the control system 32 while the second input is provided using a network connected device 622 in communication with the control system 32. Alternatively, the user of the pellet fueled cooking appliance 10 may provide the first input by using a network connected device 622 in communication with the control system 32, while the second input is provided by the user at the user interface 618 of the control system 32.

In some embodiments, where a second input is received by the control system, the method 810 of controllably energizing the hopper shaker 18 includes the step of periodically energizing the shaker 850 at a second rate. The hopper shaker 18 is periodically energized and deenergized, throughout the cooking cycle, at a rate related to, and intended to achieve, the desired cooking temperature indicated by the second input. For example, where the second input indicates a desired cooking temperature of 225 degrees Fahrenheit, the control system 32 may energize the hopper shaker 18 for a period of time and then deenergize the hopper shaker 18 for a period of approximately 30 minutes, before repeating the process. In another example, where the first input indicates a desired cooking temperature of 350 degrees Fahrenheit, the control system 32 may energize the hopper shaker 18 for a period of time and then deenergize the hopper shaker 18 for a period of approximately 15 minutes, before repeating the process. Where the second input indicates a desired cooking temperature that is different than that indicated by the first input, the second rate will differ from the first.

In some embodiments of the present disclosure, the control system 32 is configured to periodically energize and deenergize the hopper shaker 18 at regular intervals (i.e., a rate) related to the rate at which pellets are consumed by the pellet fueled cooking appliance 10. In some such embodiments, the control system 32 includes one or more sensor configured to measure the rate of pellet consumption by the pellet fueled cooking appliance 10 (e.g., a level sensor configured to measure the volume of pellets within the pellet hopper 16, a flow sensor configured to measure the flow of pellets through the hopper outlet 28, etc.). In some embodiments, where pellets are mechanically conveyed from the pellet hopper 16 to the burner 14, the control system 32 may be configured to energize the hopper shaker 18 for a period of time whenever the mechanical conveyance is actuated. For example, where the pellet fueled cooking appliance 10 is a pellet grill 210, as shown in FIG. 2, the control system 32 may be configured to periodically energize the hopper shaker for a given period of time whenever the auger motor 232 is energized to rotate the auger 230 within the auger housing 228 to feed pellets from the hopper outlet 28 to the burner 14, or fire pot 226.

In some embodiments of the present disclosure, the control system 32 is configured to energize the hopper shaker 18 indefinitely when a particular input is received from a user of the pellet fueled cooking appliance 10. For example, by energizing the hopper shaker 18 in this manner according to a corresponding input, a user of the pellet fueled cooking appliance 10 can drain the pellet hopper 16 of pellets remaining therein. In such embodiments, the control system 32 is also configured to deenergize the hopper shaker 18 indefinitely when a particular input is received from the user of the pellet fueled cooking appliance 10. This allows the user of the pellet fueled cooking appliance 10 to deenergize the hopper shaker 18 when the draining process is complete.

In some embodiments, a user of the pellet fueled cooking appliance 10 may provide inputs to the control system 32 to adjust the operating characteristics of the hopper shaker 18 (e.g., the frequency, magnitude, rate, etc., of the vibrations it generates). For example, where the hopper shaker 18 is an electric hopper shaker, as shown in FIG. 5, the user may provide an input to the control system 32 to adjust the frequency at which the shaker motor 512 rotates the shaker weight 514, thus adjusting the frequency of the vibrations created by the hopper shaker 18. The user may also provide an input to the control system 32 to adjust how long the hopper shaker 18 remains energized or deenergized, or the rate at which the hopper shaker is energized and deenergized. In some embodiments, the user may provide an input to the control system 32 to adjust the amplitude (i.e., magnitude) of the vibrations created by the hopper shaker 18.

It should be noted that although method steps may be described in a specific order, it is understood that the order of these steps may differ from what is described. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. It is understood that all such variations are within the scope of the disclosure.

While this specification contains many specific embodiment details, these should not be construed as limitations on the scope of any inventions or of what may be claimed, but rather as descriptions of features specific to particular embodiments of the systems and methods described herein. Certain features that are described in this specification in the context of separate embodiments may also be embodied in combination in a single embodiment. Conversely, various features that are described in the context of a single embodiment may also be embodied in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Having now described some illustrative embodiments and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one embodiment are not intended to be excluded from a similar role in other embodiments.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

As utilized herein with respect to numerical ranges, the terms “approximately,” “about,” “substantially,” “essentially,” and similar terms generally mean +/- 10% of the disclosed values. When the terms “approximately,” “about,” “substantially,” “essentially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act, or element may include embodiments where the act or element is based at least in part on any information, act, or element.

Any embodiment disclosed herein may be combined with any other embodiment, and references to “an embodiment,” “some embodiments,” “an alternate embodiment,” “various embodiments,” “one embodiment,” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment, inclusively or exclusively, in any manner consistent with the aspects and embodiment disclosed herein.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” “mounted,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions and embodiment of the embodiments without departing from the scope of the present disclosure as expressed in the appended claims.

What is claimed is:

1. A pellet fueled cooking appliance comprising:
a cooking body defining a cooking chamber;
a burner positioned to heat the cooking chamber when pellets are burned therein;
a pellet hopper having a hopper inlet and a hopper outlet, the pellet hopper configured to feed pellets from the hopper outlet into the burner; and
a hopper shaker mounted to the pellet hopper, wherein the hopper shaker is configured to impart a vibration to the pellet hopper to facilitate flow of pellets through the pellet hopper and into the burner.

2. The pellet fueled cooking appliance of claim 1, wherein the hopper shaker comprises a shaker motor having a motor shaft and an eccentric weight coupled to the motor shaft.

3. The pellet fueled cooking appliance of claim 2, wherein the motor shaft is oriented substantially parallel to an axis extending between the hopper inlet and the hopper outlet.

4. The pellet fueled cooking appliance of claim 1, further comprising an elastomer member positioned between the hopper shaker and the pellet hopper, wherein the elastomer member is configured to dampen vibrations imparted by the hopper shaker to the pellet hopper.

5. The pellet fueled cooking appliance of claim 1, wherein the hopper shaker is mounted to an inside surface of the pellet hopper.

6. The pellet fueled cooking appliance of claim 1, further comprising an elastomer member positioned between the pellet hopper and the cooking body, wherein the elastomer member is configured to dampen vibrations imparted by the pellet hopper to the cooking body.

7. The pellet fueled cooking appliance of claim 1, further comprising a control system configured to periodically energize the hopper shaker throughout a cooking cycle.

8. The pellet fueled cooking appliance of claim 7, wherein the control system is configured to receive an input indicative of a desired cooking temperature and to periodically energize the hopper shaker throughout the cooking cycle at a rate related to the desired cooking temperature.

9. The pellet fueled cooking appliance of claim 1, further comprising an electrical switch mounted to the cooking body, wherein the electrical switch is configured to selectively energize the hopper shaker.

10. A method of fueling a cooking appliance comprising:
feeding pellets disposed within a pellet hopper from the pellet hopper into a burner;
igniting pellets received in the burner; and
energizing a hopper shaker mounted to the pellet hopper to facilitate flow of pellets disposed within the pellet hopper from the pellet hopper to the burner.

11. The method of claim 10, wherein energizing the hopper shaker comprises selectively energizing the hopper shaker with an electrical switch mounted to the cooking appliance.

12. The method of claim 10, wherein energizing the hopper shaker comprises periodically energizing the hopper shaker at a rate related to a cooking temperature.

13. The method of claim 10, wherein energizing the hopper shaker comprises:
receiving an input indicative of a desired cooking temperature; and
periodically energizing the hopper shaker at a rate related to the desired cooking temperature.

14. The method of claim 10, wherein energizing the hopper shaker comprises:
receiving a first input indicative of a first desired cooking temperature;
periodically energizing the hopper shaker at a first rate related to the first desired cooking temperature;
receiving a second input indicative of a second desired cooking temperature; and
periodically energizing the hopper shaker at a second rate related to the second desired cooking temperature, wherein the second rate is different from the first rate.

15. A pellet grill comprising:
a cooking body defining a cooking chamber;
a pellet hopper coupled to the cooking body and having a hopper outlet;
a fire pot disposed within and configured to heat the cooking chamber;
an auger housing extending between the hopper outlet and the fire pot;
an auger positioned within the auger housing and extending between the hopper outlet and the fire pot;
an auger motor coupled to the auger, the auger motor configured to rotate the auger within the auger housing to feed pellets from the hopper outlet to the fire pot; and
a hopper shaker mounted to the pellet hopper, wherein the hopper shaker is configured to impart a vibration to the pellet hopper to facilitate flow of pellets through the pellet hopper and into the fire pot.

16. The pellet grill of claim 15, wherein the hopper shaker is vibrationally isolated from the pellet hopper by an elastomer member configured to dampen vibrations imparted by the hopper shaker to the pellet hopper.

17. The pellet grill of claim 15, wherein the pellet hopper is vibrationally isolated from the cooking body by an elastomer member configured to dampen vibration imparted by the pellet hopper to the cooking body.

18. The pellet grill of claim 15, wherein the pellet hopper further comprises a control system configured to periodically energize the hopper shaker throughout a cooking cycle.

19. The pellet grill of claim 18, wherein the control system is configured to receive an input indicative of a desired cooking temperature and to periodically energize the hopper shaker throughout the cooking cycle at a rate related to the desired cooking temperature.

20. The pellet grill of claim 15, further comprising an electrical switch coupled to the cooking body, wherein the electrical switch is configured to selectively energize the hopper shaker.
